(19) United States
(12) Patent Application Publication
(10) Pub. No.: US 2025/0308196 A1
(43) Pub. Date: Oct. 2, 2025

(54) RELOCALIZATION METHOD AND RELATED DEVICE

(71) Applicant: Beijing Zitiao Network Technology Co., Ltd., Beijing (CN)

(72) Inventor: Hengkai Guo, Beijing (CN)

(21) Appl. No.: 18/851,034

(22) PCT Filed: Mar. 3, 2023
(86) PCT No.: PCT/CN2023/079654

§ 371 Date: Sep. 25, 2024

(30) Foreign Application Priority Data
Mar. 25, 2022 (CN) 202210306850.9

(51) Int. Cl. G06V 10/44; G06T 7/246; G06T 7/70; G06V 10/46; G06V 10/74

(52) U.S. Cl. CPC G06V 10/44; G06T 7/246; G06T 7/70; G06V 10/462; G06V 10/761; G06T 2207/30244

(57) ABSTRACT

The disclosure provides a method of relocalization, including: in response to a determination that a current image frame satisfies a relocalization condition, acquiring feature points of the current image frame and descriptors of the feature points; performing, based on the feature points of the current image frame and the descriptor of each feature point, feature matching on the current image frame and each stored key frame respectively to obtain feature point pairs after matching the current image frame with each key frame respectively; determining a matching degree of the current image frame and each key frame respectively based on the feature point pairs; determining a key frame with the highest matching degree with the current image frame as a target key frame; and replacing a camera pose corresponding to the current image frame with a camera pose corresponding to the target key frame.

### CROSS-REFERENCE

The present application claims priority to Chinese Patent Application No. 202210306850.9, filed on Mar. 25, 2022, entitled “RELOCALIZATION METHOD AND RELATED DEVICE”, the entirety which is incorporated herein by reference.

### FIELD

The present disclosure relates to the field of computer vision technologies, and in particular, to a method, an apparatus and an electronic device of relocalization, a storage medium, and a program product.

### BACKGROUND

Simultaneous localization and mapping (SLAM) means that a robot carries a specific sensor to estimate a pose of the sensor during motion and simultaneously model the surrounding environment without priori information about the environment. In a case that the described sensor is mainly a camera, the SLAM may be referred to as a visual SLAM (VSLAM). The SLAM technology has been studied and developed for more than thirty years, and researchers have carried out a lot of work. In recent ten years, with the development of computer vision, the VSLAM is favored by the academia and industry due to its advantages of low hardware cost, lightweight, and high accuracy.

At present, the SLAM technology has been widely applied to various applications of augmented reality, such as plane detection and plane tracking. However, due to the existence of noise, an error may exist in the foregoing planar tracking result. In addition, an asymptotic inter-frame matching approach adopted by the SLAM technology may also accumulate an error, which can lead to drift in planar tracking results after a period of use. Therefore, how to eliminate the accumulation of errors in the planar tracking process of the SLAM becomes one of the key problems that the SLAM technology needs to solve.

### SUMMARY

In view of this, the embodiments of the present disclosure provide a method of relocalization, which can accurately determine a pose of a camera in a planar tracking process, and eliminate error accumulation in the planar tracking process, thereby ensuring accuracy of planar tracking.

According to some embodiments of the present disclosure, the described relocalization method may comprise: in response to a determination that a current image frame satisfies a relocalization condition, acquiring feature points of the current image frame and a descriptor of each feature point; performing, based on the feature points of the current image frame and the descriptor of each feature point, feature matching on the current image frame and each stored key frame respectively to obtain feature point pairs after matching the current image frame with each key frame respectively; determining a matching degree of the current image frame and each key frame respectively based on the feature point pairs; determining a key frame with the highest matching degree with the current image frame as a target key frame; and replacing a camera pose corresponding to the current image frame with a camera pose corresponding to the target key frame.

Based on the foregoing relocalization method, an embodiment of the present disclosure provides a relocalization apparatus, comprising:
a first feature point acquisition module configured to acquire, in response to a determination that a relocalization condition is satisfied, feature points of a current image frame and a descriptor of each feature point;
a first feature matching module configured to perform, based on the feature points of the current image frame and the descriptor of each feature point, feature matching on the current image frame and each stored key frame respectively to obtain feature point pairs after matching the current image frame with each key frame respectively;
a matching degree determination module configured to determine a matching degree of the current image frame and each key frame respectively based on the feature point pairs;
a target key frame determination module configured to determine a key frame with the highest matching degree with the current image frame as a target key frame; and
a pose replacement module configured to replace a camera pose corresponding to the current image frame with a camera pose corresponding to the target key frame.

In addition, the embodiments of the present disclosure also provide an electronic device, comprising a memory, a processor and a computer program stored in the memory and runnable on the processor, when executing the computer program, carries out the described relocalization.

Embodiments of the present disclosure further provide a non-transitory computer readable storage medium. The non-transitory computer-readable storage medium having computer instructions stored thereon, the computer instructions are configured to cause a computer to carry out the foregoing relocalization method.

Embodiments of the present disclosure also provide a computer program product, comprising computer program instructions which, when running on a computer, cause the computer to carry out the described relocalization method.

It can be seen from the described contents that, in the process of repetitive motion of a camera, a camera pose may drift due to accumulation of errors, thereby causing a drift in a plane tracking result. By means of the relocalization method and device provided in the present disclosure, when a camera moves back to a pose corresponding to a saved key frame, the key frame can be accurately determined. The camera pose corresponding to the current image frame is replaced with the camera pose corresponding to the key frame, so that the camera pose is directly pulled back to the camera pose corresponding to the key frame saved previously, in order to eliminate the error accumulation in the planar tracking process, solve the problem of the drift of the plane tracking caused by the error accumulation, and ensure the accuracy of plane tracking.

### BRIEF DESCRIPTION OF THE DRAWINGS

To describe the technical solutions in the present disclosure or the related art more clearly, the following briefly introduces the accompanying drawings required for describing the embodiments or the related art. Apparently, the accompanying drawings in the following description show merely embodiments of the present disclosure, and a person of ordinary skill in the art may still derive other drawings from these accompanying drawings without creative efforts.

FIG. 1 shows a flowchart of storing a key frame part in a method for relocalization according to some embodiments of the present disclosure;

FIG. 2 shows a flowchart of a camera pose relocalization based on a stored key frame according to some embodiments of the present disclosure;

FIG. 3 shows a flowchart of determining a match between a second image frame and a key frame according to some embodiments of the present disclosure;

FIG. 4 is a schematic diagram showing an internal structure of an apparatus of relocalization according to some embodiments of the present disclosure;

FIG. 5 is a schematic diagram showing the internal structure of an apparatus of relocalization according to another embodiment of the present disclosure; and

FIG. 6 is a schematic structural diagram of a more specific hardware structure of an electronic device provided by an embodiment of the present invention.

### DETAILED DESCRIPTION

In order to make objects, technical solutions and advantages of the present disclosure more apparent, the present disclosure will be further described in detail below in conjunction with specific embodiments and with reference to the accompanying drawings.

It should be noted that, unless otherwise defined, technical terms or scientific terms used in the embodiments of the present disclosure should have a common meaning understood by those skilled in the art. The terms “first”, “second”, and the like used in the embodiments of the present disclosure do not indicate any order, quantity, or importance, but are only used to distinguish different components. Words of “including” or “including” and the like mean that the element or item before the word appears to encompass the element or item listed after the word and equivalents thereof, without excluding other elements or items. Words such as “connected” or “connected” are not limited to physical or mechanical connections, but may include electrical connections, whether direct or indirect. The terms “upper”, “lower”, “left”, “right” and the like are only used for representing the relative position relationship, and when the absolute position of the described object changes, the relative position relationship may also change correspondingly.

As described above, the SLAM technology adopts an asymptotic inter-frame matching approach to perform planar tracking, and a camera pose corresponding to each image frame in a video segment may be obtained during the planar tracking. Specifically, in a planar tracking process, features of a current image frame may be extracted first to obtain a plurality of feature points of the current image frame and descriptors of the feature points; and the feature points of the current image frame are matched with the feature points of its previous image frame; then a mapping relationship between the feature points of the current image frame and its previous image frame is determined based on the feature matching results, and a camera position corresponding to the current image frame is determined based on this mapping relationship, and planes in the image frame are further tracked, etc. The foregoing mapping may be, for example, a homography matrix between two image frames or a basic matrix between two image frames. However, due to the existence of noise, results obtained by using the foregoing method, such as a camera pose corresponding to each image frame and planar tracking, may have errors. Furthermore, since all the described results are obtained based on the relationship between the current image frame and its previous image frame, after the described planar tracking process is run for a period of time, the accumulated error may also be caused, and thus the plane tracking result will have a serious drift after being used for a period of time.

To this end, some embodiments of the present disclosure provide a relocalization method, which can accurately determine a pose of a camera in a planar tracking process, eliminate error accumulation in the planar tracking process, and ensure accuracy of the planar tracking. It should be noted that, in the embodiment of the present disclosure, the foregoing relocalization method may be implemented by a planar tracking device. In embodiments of the present disclosure, the above-described planar tracking device may be an electronic device having computing capabilities. The foregoing planar tracking device may further display, through a display screen, an interaction interface capable of interacting with the user, so as to provide the user with a function of video or image processing.

The relocalization method in the embodiment of the present disclosure is generally executed after the planar tracking is performed on the current image frame, and mainly includes two parts. The content of the first part is a stored key frame, and the content of the second part is the relocalization of a camera pose based on the stored key frame. The above two parts will be described in detail hereinafter.

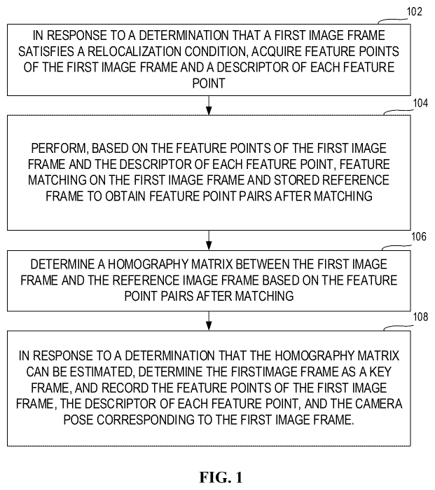

FIG. 1 shows a flowchart of storing a key frame part in a method for relocalization according to an embodiment of the present disclosure. As shown in FIG. 1, the method may comprise the following steps:

At Step 102, in response to a determination that a current image frame satisfies a relocalization condition, acquiring feature points of the current image frame and a descriptor of each feature point initial screening condition of key frame.

In an embodiment of the present disclosure, the first image frame refers to any image frame in a video which currently needs to undergo planar tracking, i.e., the first image represents a current image frame to be processed. For convenience of description, it is referred to as a first image frame in this embodiment.

In addition, the described initial screening condition of key frame is a predetermined condition for starting an operation of storing a key frame part, i. e., when it is determined that a current image frame satisfies the initial screening condition of key frame, start an operation of storing a key frame, and execute a subsequent flow; if it is determined that the current image frame does not meet the initial screening condition of key frame, the subsequent process is not executed.

In some embodiments of the present disclosure, the initial screening condition of key frame may comprise: determining that a difference between the camera pose corresponding to the first image frame and the camera pose corresponding to the saved key frame is greater than a predetermined threshold of pose difference. The threshold of pose difference threshold may comprise a threshold of distance difference and a threshold of viewing angle difference. Specifically, if it is determined that the distance between the camera pose corresponding to the first image frame and the camera pose corresponding to any key frame stored exceeds the threshold of distance difference and/or the viewing angle difference exceeds the threshold of viewing angle difference, it can be determined that the difference between the camera pose corresponding to the described first image frame and the camera pose corresponding to the stored key frame is greater than a predetermined pose difference threshold value, i.e., the first image frame satisfies the initial screening condition of key frame. This is applicable to the case where a machine automatically selects a key frame. Generally, the initial image frame of a video clip may also be automatically set as the first key frame.

In other embodiments of the present disclosure, the initial screening condition of key frame may comprise detecting a click from a user on a screen of a planar tracking device. This case applies to manual selection of key frames. When a user views a video through a screen of the foregoing planar tracing device, the user may manually determine a position of the key frame, and when it is determined that a currently displayed image frame is the key frame, select to click on the screen of the screen tracing device, so as to start an operation of storing the key frame.

It should be noted that the camera pose corresponding to the first image frame may be obtained through the foregoing planar tracing process, and details are not described herein again.

In addition, specifically, in the embodiment of the present disclosure, at Step 102, the planar tracking device may perform feature extraction on the first image frame by adopting any computer vision image feature extraction method, so as to acquire feature points of the first image frame and descriptors of the feature points. For example, the foregoing planar tracking device may perform feature extraction on the first image frame by adopting a method such as a scale-invariant feature transform (SIFT) algorithm, an Oriented FAST and Rotated BRIEF (ORB) algorithm, and a Speed Up Robust Features (SURF) algorithm, so as to acquire feature points of the first image frame and descriptors of the feature points. The feature extraction method specifically adopted at Step 102 is not limited in the present disclosure.

In other embodiments of the present disclosure, if the feature points of the first image frame and the descriptor of each feature point have been extracted and recorded previously when the first image frame is tracked in the plane, the recorded feature points of the first image frame and the descriptor of each feature point may also be read directly, and the feature extraction of the first image frame does not need to be performed again.

In other embodiments of the present disclosure, after the feature points of the first image frame and the descriptor of each feature point are obtained, it may be further determined whether the number of feature points of the first image frame is smaller than a predetermined threshold number of feature points. in response to a determination that the number of feature points of the first image frame is smaller than the feature point number threshold, it may be determined that the first image frame is not a key frame, and the described flow ends. In response to a determination that the number of feature points of the first image frame is greater than or equal to the feature point number threshold, the following step 104 may be continued.

At Step 104, performing, based on the feature points of the first image frame and the descriptors of the feature points, feature matching on the first image frame and the stored reference image frame to obtain matched feature point pairs.

In an embodiment of the present disclosure, the reference image frame may be an image frame that is processed and stored by the planar tracking device and before the first image frame. For example, the reference image frame may be a previous image frame of the first image frame. For another example, the reference image frame may be a previous key frame of the first image frame.

In an embodiment of the present disclosure, each feature point pair comprises one feature point of the first image frame further and one feature point of the reference image frame corresponding to a feature point of the first image frame. Specifically, the foregoing planar tracking device may perform feature matching based on a descriptor of each feature point. In other embodiments of the present disclosure, the foregoing planar tracking device may also track the feature points in the first image frame to the feature points in the reference image frame by using an optical flow tracking algorithm. The feature matching method specifically adopted at Step 104 is not limited in the present disclosure.

At step 106, estimating a homography matrix between the first image frame and the reference image frame from the matched pairs of feature points.

In embodiments of the present disclosure, the described planar tracking device may determine the homography matrix between the described first image frame and the described reference image frame by a random sample consensus algorithm (RANSAC).

RANSAC is an algorithm first proposed by Fischer and Bolles in 1981. The algorithm calculates a mathematical model parameter of data based on a set of sample data sets containing abnormal data. Currently, RANSAC algorithms are commonly used to find the best matching model in the matching problem of computer vision. Corresponding to the embodiments of the present disclosure, the best matching model obtained by the RANSAC algorithm by using the matched feature points is the homography matrix described in this embodiment. Specifically, the process of determining the homography matrix between the first image frame and the reference image frame by using the RANSAC algorithm may comprise: firstly, using a set of the feature point pairs as a set P; then, randomly selecting four groups of feature point pairs from the set P, and estimating a model M based on the four selected groups of feature point pairs; then, for the remaining feature point pairs in the set P, respectively calculating the distance between each feature point pair and the described model M, and when the distance exceeds a set first threshold, the feature point pair is considered as outlier or outside point; when the distance does not exceed the set threshold, the feature point pair is considered as an inlier or an inside point; after the remaining feature point pairs in the set P being calculated, recording the number mi of the inlier corresponding to the model M. Then, after repeating the above process k times, the model M corresponding to the maximum mi is selected as the final result. Definitely, if the preceding process is repeated k times, and all mi corresponding to all the models M are smaller than another set second threshold, it is considered that estimation fails, i.e., a homography matrix between the first image frame and the reference image frame cannot be obtained.

At Step 108, in response to a determination that the homography matrix can be estimated, determining the first image frame to be a key image frame, and recording feature points of the first image frame, description sub-blocks of the feature points, and a camera pose corresponding to the first image frame.

In an embodiment of the present disclosure, Step 108 can further comprise: in response to a determination that the described homography matrix cannot be estimated, determining that the described first image frame is not a key frame, and ending the described flow.

By means of the method as shown in FIG. 1, a series of key frames can be determined from various image frames of a video, and these key frames usually correspond to some relatively key camera poses, for example, there is usually some distance and/or viewpoint difference between the camera positions corresponding to these keyframes. Thus, in subsequent operations, the camera pose may be relocalized using the stored key frames.

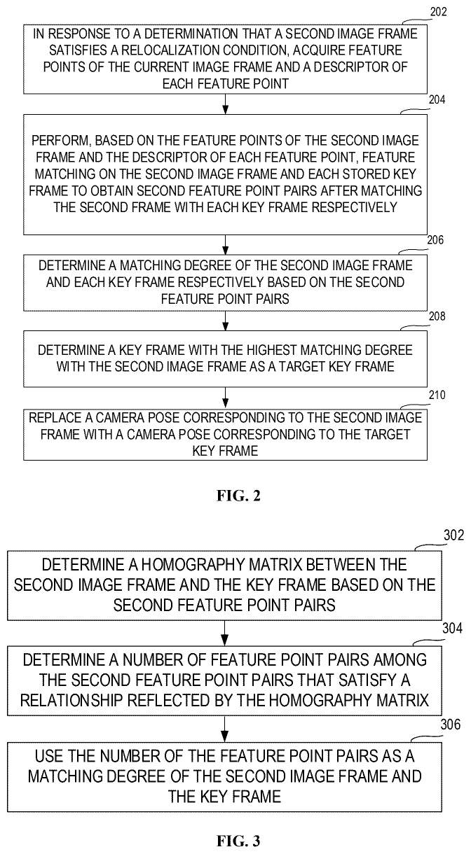

FIG. 2 shows a flowchart of a camera pose relocalization based on a stored key frame according to an embodiment of the present disclosure. As shown in FIG. 2, the method may comprise the following steps:

At Step 202, in response to a determination that the second image frame satisfies the relocalization condition, obtaining feature points of the second image frame and descriptors of the feature points.

In the embodiment of the present disclosure, the second image frame refers to any image frame in the video for which planar tracking is required, i.e., the second image frame represents the current image frame to be processed. For ease of description, the second image frame is referred to as a second image frame in this embodiment. It should be noted that, when one image frame satisfies both the initial key frame screening condition and the relocalization condition, the second image frame and the first image frame are the same image frame. In other cases, the second image frame and the first image frame may not be the same image frame.

In some embodiments of the present disclosure, the relocalization condition may comprise: the number of planar tracking failures between image frames exceeding a predetermined threshold of planar tracking failure.

As described above, in a planar tracking process, feature matching needs to be performed between an image frame and a previous image frame, and then camera pose estimation and planar tracking are performed based on feature points obtained through matching. If the camera pose cannot be estimated in the foregoing planar tracking process, it indicates that the planar tracking for the image frame fails, and in this case, the number of times of the planar tracking failure may be increased by one. In this case, the camera pose corresponding to the previous image frame may be used as the camera pose corresponding to the image frame, that is, it is assumed that the image is static. In the embodiments of the present disclosure, if the recorded number of the planar tracking failure until the current image frame, i. e., the second image frame, exceeds a predetermined threshold of planar tracking failure, it may be considered that the relocalization condition is satisfied. Additionally, in embodiments of the present disclosure, the recorded number of planar tracking failure may also be cleared to zero after the relocalization.

In some other embodiments of the present disclosure, the relocalization condition can further comprise: the planar tracking error of the adjacent image frame of the second image frame is smaller than a predetermined threshold of planar tracking error. It should be noted that, in a process of planar tracking, an error of a planar tracking result is further evaluated to obtain an error of the planar tracking. Generally, the blurrier the image frame is, the larger the error in planar tracking will be, and when the planar tracking error of the adjacent image frame of the second image frame is smaller than a predetermined threshold of planar tracking error, it means that the image of the current second image frame is not blurred, and the camera pose can be relocalized in the second image frame.

After determining that the relocalization condition is satisfied, the foregoing planar tracking device obtains feature points of the current second image frame and descriptors of the feature points.

Specifically, in the embodiment of the present disclosure, the foregoing planar tracking device obtains the feature points of the second image frame and the descriptor of each feature point by using the same method as that for obtaining the feature points of the first image frame and the descriptor of each feature point at Step 102.

For example, if the foregoing planar tracking device obtains the feature points of the first image frame and the descriptor of each feature point by using the SIFT algorithm at Step 102, the foregoing planar tracking device obtains the feature points of the second image frame and the descriptor of each feature point by using the SIFT algorithm at Step 202. For another example, if at Step 102, the foregoing planar tracking device directly obtains the feature points and the descriptor of each feature point of the first image frame obtained in the planar tracking process, at Step 202, the foregoing planar tracking device also directly obtains the feature points and the descriptor of each feature point of the second image frame obtained in the planar tracking process.

At Step 204, based on the feature points of the second image frame and the descriptors of the feature points, performing feature matching on the second image frame and each of the stored key frames respectively to obtain a second feature point pair after matching the current image frame with each key frame respectively.

In an embodiment of the present disclosure, each of the feature points pairs comprising one of the feature points of the second image frame and one of the feature points of the key frame corresponding to a feature point of the first image frame. Specifically, the foregoing planar tracking device may perform feature matching based on the descriptor of each feature point. In other embodiments of the present disclosure, the foregoing planar tracking device may also track the feature points in the second image frame to the feature points in the key frames by using an optical flow tracking algorithm. The feature matching method specifically adopted at Step 204 is not limited in the present disclosure.

At Step 206, determining a matching degree of the second image frame and each key frame based on the second feature point pairs.

In the embodiment of the present disclosure, for each keyframe, the specific implementation process of determining the matching degree of the second image frame and the keyframe based on the second feature point pair may be as shown in FIG. 3, including the following steps:

At Step 302, determining a homography matrix between the second image frame and the key frame based on the second feature point pairs.

In an embodiment of the present disclosure, the described planar tracking device may also determine the homography matrix between the described second image frame and the described key frame through the RANSAC algorithm. The specific method is as described above and will not be repeated here.

At Step 304, determining the number of the feature point pairs among the second feature point pairs that satisfy the mapping relation reflected by the corresponding homography matrix is determined.

As noted above, the RANSAC algorithm is an algorithm for finding the best matching model based on a set of sample datasets containing abnormal data. However, since the sample dataset used thereby contains abnormal data, not all the sample pairs can satisfy the best matching model obtained by means of the RANSAC algorithm. The samples that satisfy the resulting best matching model are often referred to as inlier or inside point, and the samples that do not satisfy the resulting best matching model are often referred to as outliers or outside point. Corresponding to the embodiments of the present disclosure, at Step 304, the best matching model obtained by using the matched feature points through the RANSAC algorithm is the homography matrix in this embodiment. Furthermore, it can be understood that not all feature points satisfy the transformation relationship shown in the above homography matrix. Therefore, in this step, the number of feature point pairs among all the matched feature point pairs that satisfy the relationship reflected by the above homography matrix may be determined, that is, the number of outlier may be determined.

At Step 306, using the number of pairs of feature points as the matching degree of the second image frame and the key frame.

Persons skilled in the art can understand that the greater the number of the feature points pairs satisfying the relationship reflected by the above homography matrix is, the higher the matching degree of the above second image frame and the above key frame is. For example, feature points on two image frames obtained by the camera at the same position and through shooting at the same viewing angle should satisfy the transform relationship reflected by the homography matrices obtained based on the two image frames. However, the number of feature points pairs that satisfy the transform relationship reflected by the homography matrix obtained from two image frames obtained at totally different positions or obtained from totally different viewing angles is relatively small. Therefore, in the embodiment of the present disclosure, the number of the feature point pairs is used as the matching degree of the second image frame and the key frame.

At Step 208, determining the key frame with the highest matching degree with the second image frame as the target key frame.

It can be seen therefrom that by means of the described method, a key frame with the highest matching degree with the second image frame can be determined from all the key frames as a target key frame.

In general, persons skilled in the art will appreciate that the smaller the camera pose disparity, the greater the matching degree of the images should be. Therefore, by means of the above method, a key frame with the smallest difference between a corresponding camera pose and a camera pose corresponding to the second image frame can be found from all the key frames. In other words, during the repetitive motion process of the camera, when the camera moves back to the pose for capturing one of the key frames, the key frame may be determined through the foregoing method.

At Step 210, replacing the camera pose corresponding to the second image frame with the camera pose corresponding to the target key frame.

It can be seen that, in a repetitive motion process of a camera, a camera pose may drift due to an error accumulation, thereby causing a drift in the planar tracking result. By means of the above method, the key frame can be determined when the camera moves back to the pose where the key frames is captured, and the camera pose corresponding to the second image frame is replaced with the camera pose corresponding to the key frame. Thus, the camera pose is directly pulled back to the camera pose corresponding to the key frame stored previously, so as to eliminate the error accumulation in the planar tracking process. The present invention solves the problem of planar tracking drift caused by error accumulation, and ensures the accuracy of planar tracking.

In other embodiments of the present disclosure, before Step 208, the method can further comprise: determining whether the matching degree of the current image frame and each key frame is smaller than a predetermined threshold of matching degree; and in response to a determination that the matching degree of the current image frame and each key frame is smaller than the threshold of matching degree, determining a failure of relocalization, and ending the current process. In response to a determination that the matching degree of the second image frame and each key frame is not smaller than the predetermined threshold of matching degree, proceeding to perform the above-described Step 208.

In the foregoing embodiment, when the matching degree of the second image frame and each key frame is smaller than the predetermined matching degree threshold, it indicates that the second image frame does not match each key frame, and therefore, the camera pose does not need to be replaced.

It should be noted that the method according to the embodiments of the present disclosure may be executed by a single device, such as a computer or a server. The method in this embodiment may also be applied to a distributed scenario, and multiple devices cooperate with each other to complete the method. In this distributed scenario, one of the multiple devices may execute only one or more steps in the method according to the embodiment of the present invention, and the multiple devices interact with each other to implement the method.

It should be noted that some embodiments of the present disclosure have been described above, and other embodiments are within the scope of the appended claims. In some cases, the actions or steps recited in the claims may be performed in a different order than in the embodiments described above and still achieve desirable results. In addition, the processes depicted in the figures do not necessarily require the particular order shown, or sequential order, to achieve desirable results. In certain embodiments, multitasking and parallel processing may also or may be advantageous.

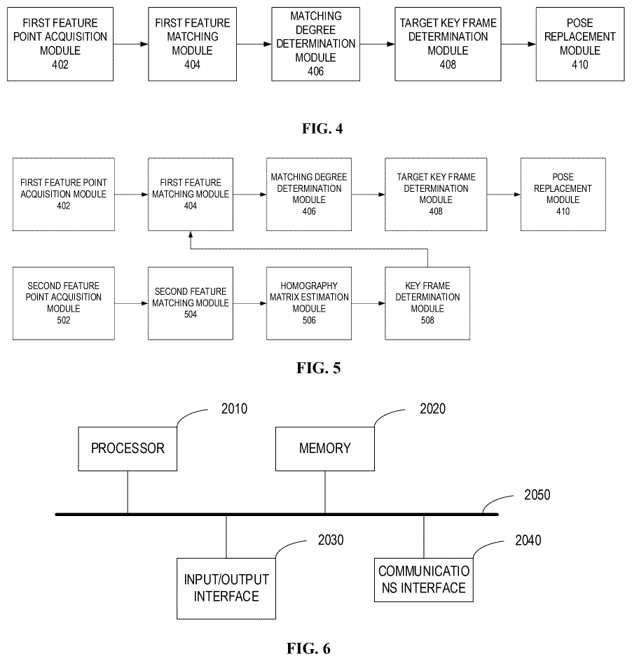

Based on the same inventive concept, corresponding to the method of any embodiment, the present disclosure further provides an apparatus of relocalization. FIG. 4 shows a schematic diagram of an internal structure of an apparatus of relocalization according to some embodiments of the present disclosure. The apparatus of relocalization shown in FIG. 4 can be located in the described planar tracking device. As shown in FIG. 4, the described apparatus of relocalization may comprise:
a first feature point acquisition module 402 configured to acquire, in response to a determination that a relocalization condition is satisfied, feature points of a current image frame and a descriptor of each feature point;
a first feature matching module 404 configured to perform, based on the feature points of the current image frame and the descriptor of each feature point, feature matching on the current image frame and each stored key frame respectively to obtain feature point pairs after matching the current image frame with each key frame respectively;
a matching degree determination module 406 configured to determine a matching degree of the current image frame and each key frame respectively based on the feature point pairs;
a target key frame determination module 408 configured to determine a key frame with the highest matching degree with the current image frame as a target key frame; and
a pose replacement module 410 configured to replace a camera pose corresponding to the current image frame with a camera pose corresponding to the target key frame.

In an embodiment of the present disclosure, the matching degree determination module 406 may comprise:
a homography matrix determination unit configured to determine, for each key frame, a homography matrix between the current image frame and the key frame based on the feature point pairs after matching the current image frame and each key frame respectively;
an inlier number determination unit configured to determine a number of feature point pairs among the feature point pairs that satisfy a relationship reflected by the homography matrix; and
a matching degree determination unit configured to determine the number of the feature point pairs as a matching degree of the current image frame and the key frame.

FIG. 5 is a schematic diagram showing the internal structure of an apparatus of relocalization according to another embodiment of the present disclosure. As shown in FIG. 5, in addition to the first feature point acquisition module 402, the first feature matching module 404, the matching degree determination module 406, the target key frame determination module 408, and the pose replacement module 410, the foregoing apparatus of relocalization can further comprise:
a second feature point acquisition module 502 configured to acquire, in response to a determination that an initial screening condition of key frame is satisfied, the feature points of the current image frame and the descriptor of each feature point;
a second feature matching module 504 configured to perform, based on the feature points of the current image frame and the descriptor of each feature point, feature matching on the current image frame and a stored reference image frame to obtain a matched second feature point pair;
a homography matrix estimation module 506 configured to estimate a homography matrix between the current image frame and the reference image frame based on the second feature point pair; and
a key frame determination module 508 configured to determine, in response to a determination that the homography matrix can be estimated, the current image frame as a key frame, and to record the feature points of the current image frame, the descriptor of each feature point, and the camera pose corresponding to the current image frame.

For specific implementation of the foregoing modules, reference may be made to the foregoing method and accompanying drawings, and details are not repeatedly described herein. For ease of description, the foregoing apparatus is described by dividing functions into various modules for separate description. Definitely, when the present disclosure is implemented, functions of each module may be implemented in one or more pieces of software and/or hardware.

The apparatus in the foregoing embodiment is configured to implement the corresponding relocalization method in any one of the foregoing embodiments, and has beneficial effects of the corresponding method embodiment, which are not described herein again.

Based on the same inventive concept, corresponding to the method of any of the described embodiments, the present disclosure further provides an electronic device, comprising a memory, a processor and a computer program stored in the memory and runnable on the processor, the processor, when executing the computer program, carries out the method of any of the described embodiments.

FIG. 6 shows a more specific schematic structural diagram of hardware structure of an electronic device provided by this embodiment. The device may comprise: a processor 2010, a memory 2020, an input/output interface 2030, a communications interface 2040, and a bus 2050. The processor 2010, the memory 2020, the input/output interface 2030, and the communication interface 2040 implement a communication connection between each other inside the device through the bus 2050.

The processor 2010 may be implemented by using a general CPU (Central Processing Unit), a microprocessor, an application specific integrated circuit (Application Specific Integrated Circuit, ASIC), or one or more integrated circuits, and is configured to execute a relevant program, so as to implement the technical solutions provided in the embodiments of the specification.

The memory 2020 may be implemented in the form of a read only memory (ROM), a random access memory (RAM), a static storage device, and a dynamic storage device. The memory 2020 may store an operating system and other application programs. When the technical solutions provided in the embodiments of the present description are implemented by software or firmware, related program codes are stored in the memory 2020 and invoked and executed by the processor 2010.

The input/output interface 2030 is configured to connect to an input/output module, so as to implement information input and output. The input/output module may be configured in a device (not shown in the figure) as a component, and may also be externally connected to the device to provide a corresponding function. The input device may comprise a keyboard, a mouse, a touch screen, a microphone, various sensors, and the like, and the output device may comprise a display, a speaker, a vibrator, an indicator lamp, and the like.

The communications interface 2040 is configured to connect to a communications module (not shown in the figure), so as to implement communication interaction between this device and other devices. The communication module may implement communication in a wired manner (such as a USB and a network cable), and may also implement communication in a wireless manner (such as a mobile network, WIFI, and Bluetooth).

The bus 2050 comprises a path that transfers information between various components of the device, such as the processor 2010, the memory 2020, the input/output interface 2030, and the communication interface 2040.

It should be noted that, although the foregoing device only shows the processor 2010, the memory 2020, the input/output interface 2030, the communications interface 2040, and the bus 2050, in a specific implementation process, the device can further include other components necessary for implementing normal running. In addition, persons skilled in the art may understand that the foregoing device may also only comprise components necessary for implementing solutions of embodiments of the present specification, and does not necessarily comprise all components shown in the figure.

The electronic device in the foregoing embodiment is configured to implement the corresponding relocalization method in any one of the foregoing embodiments, and has beneficial effects of the corresponding method embodiment, which are not described herein again.

Based on the same inventive concept, corresponding to the method of any of the above embodiments, the present disclosure further provides a non-transitory computer readable storage medium having computer instructions stored thereon, the computer instructions are configured to cause a computer to carry out the method of any of the above embodiments.

The computer readable media of this embodiment, comprising both persistent and non-persistent, removable and non-removable media, may be any method or technology for storage of information. The information may be computer readable instructions, data structures, modules of a program, or other data. Examples of computer storage media include, but not limited to phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disc read-only memory (CD-ROM), digital versatile discs (DVD) or other optical storage, magnetic cassettes, magnetic tape magnetic disk storage or other magnetic storage devices, or any other non-transmission medium, may be used to store information that may be accessed by a computing device.

The computer instruction stored in the storage medium of the foregoing embodiment is used to cause the computer to execute the task processing method according to any one of the foregoing embodiments, and has beneficial effects of the corresponding method embodiments, which are not described herein again.

It should be understood by persons skilled in the art that the discussion of any embodiment above is merely an example and is not intended to imply that the scope of the present disclosure, including the claims, is limited to these examples. In the concept of the present disclosure, the technical features in the above embodiments or different embodiments may also be combined, the steps may be implemented in any order, and there are many other variations on different aspects of the embodiments of the present disclosure as described above, which are not provided in detail for simplicity.

In addition, well-known power/ground connections to integrated circuit (IC) chips and other components may or may not be shown in the provided drawings for simplicity of illustration and discussion, and so as not to obscure embodiments of the present disclosure. Furthermore, the apparatus may be shown in block diagram form in order to avoid obscuring embodiments of the present disclosure, and this also takes into account the fact that details with respect to embodiments of these block diagram apparatus are highly dependent upon the platform on which the embodiments of the present disclosure are to be implemented (i. e., such specifics should be well within purview of those skilled in the art). Where specific details (e. g., circuits) are set forth in order to describe example embodiments of the disclosure, it should be apparent to those skilled in the art that embodiments of the disclosure may be practiced without, or with variation of, these specific details. Therefore, these descriptions should be regarded as illustrative rather than restrictive.

Although the present disclosure has been described in conjunction with specific embodiments of the present disclosure, many alternatives, modifications, and variations of these embodiments will be apparent to those of ordinary skill in the art in light of the foregoing description. For example, other memory architectures (e. g., dynamic RAM (DRAM)) may use the discussed embodiments.

It is intended that embodiments of the present disclosure cover all such alternatives, modifications and variations as belong to the broad scope of the appended claims. Therefore, any omissions, modifications, equivalents and improvements made without departing from the spirit and principle of the embodiments of the present disclosure shall belong to the scope of protection of the present disclosure.

1. A method of relocalization, comprising:
in response to a determination that a current image frame satisfies a relocalization condition, acquiring feature points of the current image frame and a descriptor of each feature point;
performing, based on the feature points of the current image frame and the descriptor of each feature point, feature matching on the current image frame and each stored key frame respectively to obtain feature point pairs after matching the current image frame with each key frame respectively;
determining a matching degree of the current image frame and each key frame respectively based on the feature point pairs;
determining a key frame with the highest matching degree with the current image frame as a target key frame; and
replacing a camera pose corresponding to the current image frame with a camera pose corresponding to the target key frame.

2. The method of relocalization of claim 1, wherein the relocalization condition comprises: a number of planar tracking failures between image frames exceeding a predetermined threshold of planar tracking failure.

3. The method of relocalization of claim 2, wherein the relocalization condition further comprises: a planar tracking error of an adjacent image frame of the current image frame is smaller than a predetermined threshold of plane tracking error.

4. The method of relocalization of claim 1, wherein the determining a matching degree of the current image frame and each key frame respectively based on the feature point pairs after matching the current image frame and each key frame respectively comprises:
for each key frame, performing the following:
determining a homography matrix between the current image frame and the key frame based on the feature points pairs;
determining a number of feature point pairs among the feature point pairs that satisfy a relationship reflected by the homography matrix; and
using the number of the feature point pairs as a matching degree of the current image frame and the key frame.

5. The method of relocalization of claim 1, further comprising:
determining whether the matching degree of the current image frame and each key frame is smaller than a predetermined threshold of matching degree; and
in response to a determination that the matching degree of the current image frame and each key frame is smaller than the threshold of matching degree, determining a failure of relocalization, and ending the current process.

6. The method of relocalization of claim 1, further comprising:
in response to a determination that the current image frame satisfies an initial screening condition of key frame, acquiring the feature points of the current image frame and the descriptor of each feature point;
performing, based on the feature points of the current image frame and the descriptor of each feature point, feature matching on the current image frame and a stored reference image frame to obtain a matched second feature point pair;
estimating a homography matrix between the current image frame and the reference image frame based on the second feature point pair; and
in response to a determination that the homography matrix can be estimated, determining the current image frame as a key frame, and recording the feature points of the current image frame, the descriptor of each feature point, and the camera pose corresponding to the current image frame.

7. The method of relocalization of claim 6, wherein the initial screening condition of key frame comprises: detecting a click from a user on a screen of a planar tracking device, or determining that a difference between the camera pose corresponding to the current image frame and a camera pose corresponding to each key frame is greater than a predetermined threshold of pose difference.

8. The method of relocalization of claim 6, further comprising:
in response to a determination that a number of the feature points of the current image frame is smaller than a predetermined threshold number of feature points, determining that the current image frame is not a key frame, and ending the current process; or,
in response to a determination that the homography matrix cannot be estimated, determining that the current image frame is not a key frame, and ending the current process.

9. The method of relocalization of claim 1, wherein the acquiring feature points of the current image frame and a descriptor of each feature point comprises:
performing feature extraction on the current image frame by using a scale-invariant feature transform (SIFT) algorithm, an oriented FAST and rotated brief (ORB) algorithm or a speed up robust features (SURF) algorithm to acquire the feature points of the current image frame and the descriptor of each feature point; or
reading the recorded feature points of the current image frame and the descriptor of each feature point.

10. The method of relocalization of claim 1, wherein the performing feature matching on the current image frame and each stored key frame respectively comprises: tracking feature points in the current image frame to feature points in each of the key frames by using an optical flow tracking algorithm.

11. The method of relocalization of claim 6, wherein the performing feature matching on the current image frame and a stored reference image frame comprises: tracking feature points in the current image frame to feature points in the reference image frame by using an optical flow tracking algorithm.

12. (canceled)

13. (canceled)

14. (canceled)

15. An electronic device, comprising a memory, a processor and a computer program stored in the memory and runnable on the processor, the processor, when executing the computer program, carries out a method comprising:
performing, based on the feature points of the current image frame and the descriptor of each feature point, feature matching on the current image frame and each stored key frame respectively to obtain feature point pairs after matching the current image frame with each key frame respectively;
determining a matching degree of the current image frame and each key frame respectively based on the feature point pairs;
determining a key frame with the highest matching degree with the current image frame as a target key frame; and
replacing a camera pose corresponding to the current image frame with a camera pose corresponding to the target key frame.

16. A non-transitory computer readable storage medium having computer instructions stored thereon, the computer instructions are configured to cause a computer to carry out a method comprising:
in response to a determination that a current image frame satisfies a relocalization condition, acquiring feature points of the current image frame and a descriptor of each feature point;
performing, based on the feature points of the current image frame and the descriptor of each feature point, feature matching on the current image frame and each stored key frame respectively to obtain feature point pairs after matching the current image frame with each key frame respectively;
determining a matching degree of the current image frame and each key frame respectively based on the feature point pairs;
determining a key frame with the highest matching degree with the current image frame as a target key frame; and
replacing a camera pose corresponding to the current image frame with a camera pose corresponding to the target key frame.

17. (canceled)

18. The electronic device of claim 15, wherein the relocalization condition comprises: a number of planar tracking failures between image frames exceeding a predetermined threshold of planar tracking failure.

19. The electronic device of claim 16, the relocalization condition further comprises: a planar tracking error of an adjacent image frame of the current image frame is smaller than a predetermined threshold of plane tracking error.

20. The electronic device of claim 15, wherein the determining a matching degree of the current image frame and each key frame respectively based on the feature point pairs after matching the current image frame and each key frame respectively comprises:
for each key frame, performing the following:
determining a homography matrix between the current image frame and the key frame based on the feature points pairs;
determining a number of feature point pairs among the feature point pairs that satisfy a relationship reflected by the homography matrix; and
using the number of the feature point pairs as a matching degree of the current image frame and the key frame.

21. The electronic device of claim 15, wherein the processor, when executing the computer program, carries out the method further comprising:
determining whether the matching degree of the current image frame and each key frame is smaller than a predetermined threshold of matching degree; and
in response to a determination that the matching degree of the current image frame and each key frame is smaller than the threshold of matching degree, determining a failure of relocalization, and ending the current process.

22. The electronic device of claim 15, wherein the processor, when executing the computer program, carries out the method further comprising:
in response to a determination that the current image frame satisfies an initial screening condition of key frame, acquiring the feature points of the current image frame and the descriptor of each feature point;
performing, based on the feature points of the current image frame and the descriptor of each feature point, feature matching on the current image frame and a stored reference image frame to obtain a matched second feature point pair;
estimating a homography matrix between the current image frame and the reference image frame based on the second feature point pair; and
in response to a determination that the homography matrix can be estimated, determining the current image frame as a key frame, and recording the feature points of the current image frame, the descriptor of each feature point, and the camera pose corresponding to the current image frame.

23. The electronic device of claim 22, wherein the initial screening condition of key frame comprises: detecting a click from a user on a screen of a planar tracking device, or determining that a difference between the camera pose corresponding to the current image frame and a camera pose corresponding to each key frame is greater than a predetermined threshold of pose difference.

24. The electronic device of claim 22, wherein the processor, when executing the computer program, carries out the method further comprising:
in response to a determination that a number of the feature points of the current image frame is smaller than a predetermined threshold number of feature points, determining that the current image frame is not a key frame, and ending the current process; or,
in response to a determination that the homography matrix cannot be estimated, determining that the current image frame is not a key frame, and ending the current process.
